(19) United States
(12) Patent Application Publication
(10) Pub. No.: US 2019/0285529 A1
(43) Pub. Date: Sep. 19, 2019

(54) DIFFUSIVE GRADIENT IN THIN-FILMS DEVICE AND APPARATUS FOR DEVELOPING SUCH A DEVICE

(71) Applicant: INSTITUT DE RADIOPROTECTION ET DE SURETE NUCLEAIRE, Fontenay Aux Roses (FR)

(72) Inventors: Géraldine CASTEL, Le Plessis-Robinson (FR); Damien TOURNIEUX, Pertuis (FR)

(21) Appl. No.: 16/318,786

(22) PCT Filed: Jul. 13, 2017
(86) PCT No.: PCT/EP2017/067738

§ 371 Date: Jan. 18, 2019

(30) Foreign Application Priority Data
Jul. 20, 2016 (FR) 16 56924

(51) Int. Cl. G01N 13/00; G01N 1/22

(52) U.S. Cl. CPC G01N 13/00; G01N 2013/003; G01N 1/2273

(57) ABSTRACT

The invention relates to a diffusive gradient in thin-films device comprising a casing (2) comprising a first portion and a second portion defining therebetween a housing (3) for accommodating at least one component-diffusing layer (4), said component coming from an environment exterior to the device. According to the invention, the casing includes at least two orifices (6, 7) ensuring the exposure of the diffusion layer to the exterior of the device. The invention also relates to an apparatus for developing a diffusive gradient in thin-films device comprising such a device.

The invention relates to a diffusive gradient in thin-films device. The invention also relates to an apparatus for developing such a device.

### TECHNOLOGICAL BACKGROUND OF THE INVENTION

Diffusive gradient in thin-films devices were developed during the 1990s with the aim of measuring metals present in a given medium in order to study the level of pollution of this medium.

Typically, a diffusive gradient in thin-films device includes a binding layer having element absorbing properties and a diffusion layer in order to control the transport flow of the elements from the surrounding medium toward the binding layer.

Once the diffusive gradient in thin-films device has been submerged in the medium to be studied, the metal cations of the surrounding medium migrate through the diffusion layer toward the binding layer and are thus trapped in the binding layer. The study of the binding layer, once the diffusive gradient in thin-films device has been recovered, will thus make it possible to establish the concentration of metals in the surrounding medium.

Such a device therefore makes it possible to simply study a given medium.

However, diffusive gradient in thin-films devices only allow a short exposure, less than 48 hours, of the medium to be studied since the binding layer becomes quickly saturated.

### OBJECT OF THE INVENTION

An aim of the invention is to propose a diffusive gradient in thin-films device which allows a more prolonged exposure than the current devices. An aim of the invention is also to propose an apparatus for developing such a device.

### BRIEF DESCRIPTION OF THE INVENTION

To achieve this aim, a diffusive gradient in thin-films device is proposed which comprises a casing comprising a first part and a second part which define therebetween a housing for receiving at least one diffusion layer for at least one component coming from a medium outside the device.

According to the invention, the casing includes at least two holes exposing the diffusion layer to the outside of the device.

Thus, the diffusive gradient in thin-films device has at least two separate holes and this makes it possible to slow the rate of diffusion of components of the outside medium in said device.

This temporarily delays the moment when the device will be saturated with components to be studied thus making it possible to use the device for longer.

By adjusting the number of holes and/or the dimensions of the various holes, it is therefore possible to control the rate of diffusion of the studied components and therefore to adjust a diffusive gradient in thin-films device according to the invention to a desired deployment time. The invention therefore proves to be adjustable.

Thus, the inventors have been able to develop prototypes allowing an exposure, in the medium to be studied, of up to several weeks.

The device furthermore has a simple shape allowing easy manufacture at a lower cost and with high reproducibility.

According to a specific embodiment, the device includes a binding layer arranged in the housing such that the diffusion layer extends from the first part as far as the binding layer which itself extends as far as the second part.

According to a specific embodiment, the two holes are provided such as to both expose the diffusion layer to the medium to be studied.

According to a specific embodiment, the two holes are provided in the first part of the casing such as to pass through the first part in order to firstly open out at the housing on the diffusion layer side and to secondly open out onto the outside of the device.

According to a specific embodiment, a first hole is provided in the first part of the casing such as to pass through the first part in order to firstly open out at the housing on the diffusion layer side and to secondly open out onto the outside of the device and wherein a second hole is provided in the second part of the casing such as to pass through the second part in order to firstly open out at the housing on the diffusion layer side and to secondly open out onto the outside of the device.

According to a specific embodiment, the various holes are provided such as to extend in directions that are parallel to one another.

According to a specific embodiment, the various holes have a circular section.

According to a specific embodiment, the various holes all have a cylinder shape.

According to a specific embodiment, the two parts are screwed together.

The invention also relates to a developing apparatus comprising the diffusive gradient in thin-films device as described above for diffusing components from a first compartment intended to receive the solution to be studied toward a second compartment intended to receive a reference solution.

If no binding layer is arranged in the device, it is the solution to be studied which will fill the role of the binding layer which will make it possible to relatively effectively study the diffusive gradient in thin-films device (characterization of the diffusion coefficient, physicochemical parameters of the diffusion layer, etc.).

This will particularly make it possible to develop the diffusive gradient in thin-films device in order to adjust said device to a desired deployment time.

In particular, the apparatus includes a container including a wall separating the container into two compartments with one intended to receive the solution to be studied and the other intended to receive the reference solution, the thin-films device being arranged in a removable manner, with regard to the first part thereof and the second part thereof, at the wall.

In particular, the second part includes a wall separating the container into two compartments with one intended to receive the solution to be studied and the other intended to receive the reference solution, the first part being arranged in a removable manner on the second part.

### BRIEF DESCRIPTION OF THE DRAWINGS

The invention will be better understood in light of the following description of specific nonlimiting embodiments of the invention.

Reference will be made to the appended figures wherein:

FIG. 1 is an exploded perspective view of a casing of a diffusive gradient in thin-films device according to a first embodiment of the invention,

FIG. 2 is a sectional view of a diffusive gradient in thin-films device comprising the casing illustrated in FIG. 1,

FIG. 3 is a perspective view of a part of a casing of a diffusive gradient in thin-films device according to a second embodiment of the invention,

FIG. 4 is a perspective view of an apparatus for developing the diffusive gradient in thin-films device as illustrated in FIG. 2,

FIG. 5 is a perspective view of a casing of a diffusive gradient in thin-films device according to a third embodiment used in the developing apparatus illustrated in FIG. 4,

FIGS. 6 and 7 are perspective views, respectively, of one of the parts of the casing illustrated in FIG. 5.

### DETAILED DESCRIPTION OF THE INVENTION

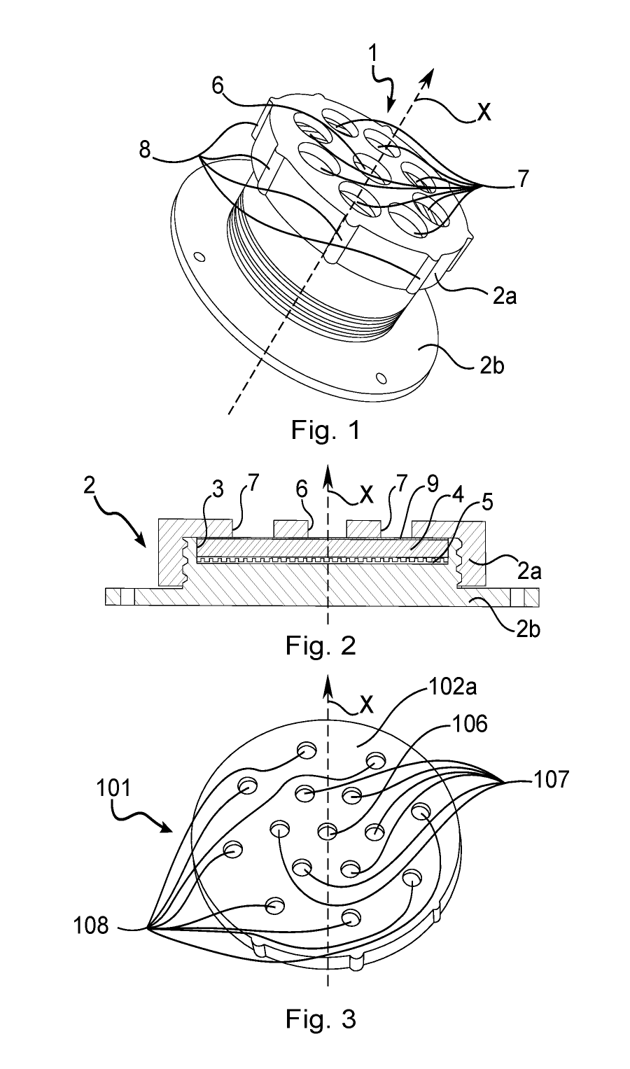

With reference to FIGS. 1 and 2, the diffusive gradient in thin-films device 1 according to the first embodiment of the invention comprises a casing 2 comprising a first part 2a and a second part 2b. The casing 2 is made of plastic for example. Such a casing 2 is, for example, manufactured using a 3D printer.

The two parts 2a, 2b are arranged such as to extend in this case concentrically along an axis X (the reinforcements 11 therefore extending parallel to said axis X in this case).

In this case, the first part 2a has an axis X generator generally cylindrical shape.

The second part 2b in this case includes an axis X generator cylindrical first portion and an axis X generator cylindrical second portion extending as a continuation of the first cylindrical portion with a larger diameter and a smaller thickness than the first portion.

The two parts 2a, 2b are, for example, screwed together. To this end, the second part 2b includes, for example, a threading arranged externally on the cylindrical face of the first portion and the first part 2a includes a corresponding threading arranged internally on the cylindrical face thereof.

In order to facilitate the screwing between the two parts 2a, 2b, the first part 2a includes axial reinforcements 8. Said reinforcements 8 extend in this case over the entire height of the first part 2a externally over the cylindrical face thereof. Said reinforcements 8 are distributed at regular intervals over the entire perimeter of the first part 2a.

The two parts 2a, 2b are arranged such as to define therebetween a housing 3 axially extending along the axis X. The housing 3 is cylindrical in this case.

The device 1 further includes a diffusion layer 4 and a binding layer 5 arranged in the housing 3 such that the diffusion layer 4 extends from the first part 2a as far as the binding layer 5 which itself extends as far as the second part 2b. In particular, the device 1 also includes a hydrophilic membrane layer 9 arranged on the diffusion layer 4, in the housing 3, between the diffusion layer 4 and the first part 2a.

The various layers 4, 5, 9 are also cylindrical.

Typically, the diffusion layer 4 is hydrogel-based. The hydrogel is agarose-based for example.

The binding layer 5 is typically formed from a resin. The resin is, for example, Chelex 100 (registered trademark).

Such a device 1 is suitable for trapping various components (radionuclide, metal, ion, organic compound which are polar/nonpolar, etc.) depending on the chosen materials of the diffusion layer and of the binding layer and depending on the porosity of the hydrophilic membrane layer that is chosen.

The two parts 2a, 2b are, of course, shaped such as to hold in position the various layers 4, 5, 9 in the housing 3. Advantageously, the screw pitch between the two parts 2a, 2b makes it possible to adjust the height of the housing 3 (along the axis X) and thus to adjust the casing 2 to different layer thicknesses.

Preferably, the second part 2b includes means for affixing wedges making it possible to further modify the height of the housing 3 and thus adjust the casing 2 to a greater number of different layer thicknesses.

The casing 2 includes at least two holes exposing the diffusion layer 4 to the outside of the casing 2. In this case, the holes are provided such as to expose the diffusion layer 4 to the medium to be studied.

The various holes are thus provided in the first part 2a of the casing 2 such as to pass through the first part 2a in order to firstly open out at the housing 3 on the diffusion layer 4 side and to secondly open out onto the outside of the device 1.

The various holes are provided such as to extend, in this case, in directions that are merged with or parallel to the axis X. The various holes in this case have a circular section (along the axis X). The various holes all have a cylinder shape in this case. The various holes have the same radius right long the axis X.

In the first described embodiment, the first part 2a includes nine holes. The various holes in this case are distributed uniformly over the first part 2a. For example, a central hole 6 extends concentrically to the first part 2a along the axis X and the other eight holes 7 are provided in the first part 2a such as to extend around the central hole 6 parallel to the axis X. The other eight holes 7 are thus provided such as to produce a cylinder surrounding the central hole.

In particular, the diameter of the first part 2a is between 1 and 20 centimeters. The volume of each hole of the first part 2a is between 0.09 and 0.13 cubic centimeters and preferably between 0.10 and 0.12 cubic centimeters. The diameter of each hole of the first part 2a is between 0.70 and 1.00 centimeters and preferably between 0.80 and 0.90 centimeters.

In particular, the diameter of the second part 2b (outside the area thereof for screwing to the first part 2a) is between 3 and 4 centimeters. Preferably, the diameter of the second part 2b (outside the area thereof for screwing to the first part 2a) is 3.5 centimeters.

Such a device 1 complies with the ISO-5567-23 standard.

FIG. 3 illustrates a second embodiment. In this second embodiment, the diffusive gradient in thin-films device 101 is identical to the diffusive gradient in thin-films device 1 according to the first embodiment with the difference that the first part 102a this time includes fifteen holes instead of nine.

In this case, the various holes have a circular section (along the axis X). The various holes are all cylindrical in this case. The various holes have the same radius right along the axis X.

A first central hole 106 is in this case provided such as to extend concentrically to the first part 2a along the axis X.

Six other holes 107 are provided in the first part 102a such as to extend around the central hole 106 parallel to the axis X. Said six holes 107 are thus provided such as to produce a first cylinder surrounding the central hole 106.

Eight other holes 108 are provided in the first part 102a such as to extend around the central hole 106 parallel to the axis X. Said eight holes 108 are thus provided such as to produce a second cylinder externally surrounding the first cylinder.

In particular, the diameter of the first part 102a is between 1 and 20 centimeters. The volume of each hole of the first part 102a is between 0.005 and 0.020 cubic centimeters and preferably between 0.010 and 0.015 cubic centimeters. The diameter of each hole of the first part 102a is between 0.20 and 0.40 centimeters and preferably between 0.25 and 0.35 centimeters.

In particular, the diameter of the second part (outside the area thereof for screwing to the first part 102a) is between 3 and 4 centimeters. Preferably, the diameter of the second part (outside the area thereof for screwing to the first part 102a) is approximately 3.5 centimeters.

Other geometries of a diffusive gradient in thin-films device according to the invention can be envisaged depending on the exposure time of the diffusive gradient in thin-films device that is desired.

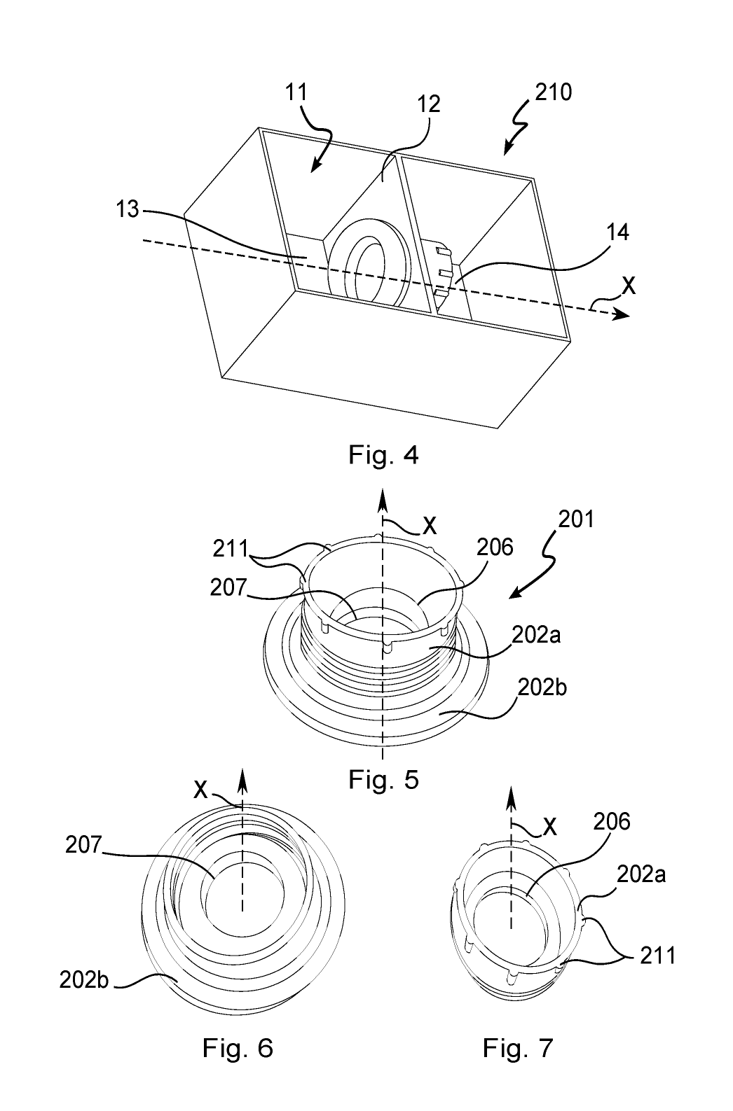

To this end and with reference to FIG. 4, the developing apparatus 10 makes it possible to characterize various parameters of a diffusive gradient in thin-films device in order to adjust it to the target exposure time.

For example, the apparatus includes a container 11. The container 11 is, for example, made of plastic. Such a container 11 is, for example, manufactured using a 3D printer.

The container 11 includes a wall 12 separating the container 11 into two compartments. Said wall 12 is in this case central such that the two compartments have the same volume.

The wall 12 includes an opening. The opening is in this case centered on the wall 12 for practicality. The apparatus 10 further comprises a diffusive gradient in thin-films device 201 according to a third embodiment of the invention, which is arranged in said opening in order to diffuse components from one of the compartments toward the other of the compartments.

The device 201 is, for example, targeted into said opening.

As can be seen more clearly in FIGS. 5 to 7, the diffusive gradient in thin-films device 201 according to the third embodiment of the invention comprises a casing 202 comprising a first part 202a and a second part 202b. The casing 202 is made of plastic for example. Such a casing 202 is manufactured is, for example, using a 3D printer.

The second part 202b includes, on the outer perimeter thereof, a threading for screwing it to the wall 12, the wall 12 including a corresponding threading. Preferably, the second part 202b includes a first cylindrical portion and a second cylindrical portion extending as a continuation of the first cylindrical portion with a greater diameter and a smaller thickness than the first portion. In particular, the second part 202b thus includes a threading on the cylindrical outer contour of the first portion for screwing inside the wall 12 and also a threading on the circular main face of the second portion intended to be targeted onto the face opposite of the wall 12. Preferably, said face of the wall 12 includes a reinforcement in which the corresponding threading is provided to enable to more effectively pressing the second part 202b onto the wall 12.

The two parts 202a, 202b are, for example, screwed together such that, in position on the central wall 12, the first part 202a is arranged in the first compartment 14 and the second part 202b is arranged in the second compartment 13. To this end, the second part 202b includes an inner threading and the first part 202a includes an outer corresponding threading for screwing the first part 202a inside the second part 202b. The threading of the second part 202b is thus arranged inside the first portion. The first part 202a has, in this case, a generally cylindrical shape and the threading is arranged on the cylindrical external contour.

To facilitate the screwing together of the two parts 202a, 202b, the first part 202a includes axial reinforcements 211 (only some of which are numbered in FIGS. 5 and 7). Said reinforcements 211 in this case extend over the entire height of the first part 202a. Said reinforcements 211 are distributed at regular intervals over the entire perimeter of the first part 202a.

The two parts 202a, 202b are arranged such as to extend concentrically along an axis X (the reinforcements 211 therefore extend in this case parallel to the axis X).

The two parts 202a, 202b are arranged such as to define therebetween a receiving housing axially extending along the axis X. In this case, the housing is cylindrical.

The device 201 further includes a diffusion layer arranged in the housing. The device 201 thus does not include any binding layer for this embodiment. In particular, the device 201 also includes a hydrophilic membrane layer arranged on the diffusion layer in the housing between the diffusion layer and the first part. In an alternative, the device 201 does not include any hydrophilic membrane layer.

In this case, the device only includes a diffusion layer in the housing.

The diffusion layer and the hydrophilic membrane layer are also cylindrical.

Typically, the diffusion layer is hydrogel-based. For example, the hydrogel is agarose-based.

The two parts 202a, 202b are, of course, shaped such as to hold in position the diffusion layer and the hydrophilic membrane layer in the housing. Advantageously, the screw pitch between the two parts 202a, 202b makes it possible to adjust the height of the housing (along the axis X) and thus adjust the casing to different thicknesses of layer.

Preferably, the second part 202b includes means for affixing wedges making it possible to further modify the height of the housing and thus adjust the casing to a greater number of different thicknesses of layer.

The casing includes at least two holes exposing the diffusion layer to the outside of the casing 202. In this case, the two holes are provided such as to expose the diffusion layer firstly to the first compartment 13 and secondly to the second compartment 14.

The various holes are provided such as to extend in this case along directions that are merged with or parallel to the axis X. The various holes in this case have a circular section (along the axis X).

One of the holes 206 is provided in the first part 202a of the casing 202 such as to pass through the first part 202a in order to firstly open out at the housing on the diffusion layer side and to secondly open out at the first compartment 13. The hole 206 in this case is a central hole extends concentrically to the first part 202a along the axis X.

In particular, the diameter of the first part 202a is between 2 and 8 centimeters. The volume of the hole 206 of the first part 202a is between 0.85 and 1.1 cubic centimeters and preferably between 0.95 and 1.0 cubic centimeters. The diameter of the hole of the first part 202a is between 2 and 3 centimeters and preferably is 2.5 centimeters.

In particular, the diameter of the second part (outside the area thereof for screwing to the first part 202a) is between 3 and 4 centimeters. Preferably, the diameter of the second part (outside the area thereof for screwing to the first part 202a) is approximately 3.5 centimeters.

For the diffusion between the two compartments 13, 14, the second part 202b also includes in this case a hole 207 which is provided in the second part 202b of the casing 202 such as to pass through the second part 202b in order to firstly open out at the housing on the diffusion layer side and to secondly open out at the second compartment 14. The hole 207 is in this case a central hole extending concentrically to the second part 14 along the axis X. The diameter of said hole 207 is preferably the same as the diameter of the hole 206 of the first part 202a. The diameter of the hole 207 of the second part 202b is between 2 and 3 centimeters and is preferably 2.5 centimeters. The diameter of the hole 207 of the second part 202b is between 60% and 80% of the diameter of the second part 202b.

In this manner, the diffusive gradient in thin-films device 201 according to the third embodiment of the invention turns out to be a pass-through device, the diffusion layer however being arranged through the passage extending in the first part 202a and the second part 202b between the two ends of the device. Said device is furthermore arranged at the wall 12 such that said passage forms the only means allowing compounds to pass from the first compartment 13 to the second compartment 14 through the hydrophilic membrane layer and the diffusion layer.

The device possibly includes a seal (not shown in this case) arranged between the device and the wall 12 in order to provide a good level of tightness at the junction between the central wall and the device.

Such a device complies with the ISO-5667-23 standard.

A method of using the apparatus will now be described.

The second compartment 14 is filled with purified water. This water simulates, in reality, a binding layer which could be arranged in the diffusive gradient in thin-films device.

The first compartment 13 includes a reference solution. The reference solution is more concentrated than the purified water such that natural diffusion takes place from the reference solution to the purified water. The reference solution has a salt concentration for example.

Preferably, magnetic agitators are present in each compartment in order to ensure the homogeneity of the solution in each compartment.

Thus, various components will pass from the first compartment 13 to the second compartment 14 through the hydrophilic membrane layer and the diffusion layer at a constant rate until tending toward an equilibrium position. At the end of a given exposure time, the components found in the second compartment 14 are studied.

By modifying the geometry and/or the diffusion layer of the diffusive gradient in thin-films device and by again carrying out the aforementioned experiment, it is therefore possible to retrieve other data making it possible to characterize the device and particularly the first part thereof and the diffusion layer thereof.

Thus, it is possible to assess which first part geometry and which geometry and material of the diffusion layer are the most suitable for a type of given use.

For example, it is possible to assess the contact surface of the diffusion layer with the surrounding medium (defined in particular by the number of holes of the first part and the dimensions of said holes) and the thickness of the diffusion layer making it possible to achieve a given diffusion rate leading to an exposure time of the device.

Thus, it is possible to assess the shape and the composition of a diffusive gradient in thin-films device suited to an exposure time of the device that is the target.

The invention is not limited to the description given above, but, on the contrary, covers any alternative falling within the scope defined by the claims.

In particular, the diffusive gradient in thin-films device can include a different number of holes than that indicated provided it includes at least two holes.

The holes can also be provided differently to the description given above. In the case of the third embodiment where the first part, like the second part, includes a hole, the first part and the second part can thus each include more than one hole.

Moreover, the diffusive gradient device can be associated with one or more other diffusive gradient devices according to the invention and/or with one or more other means for trapping radioelements like, for example, radioelements present in air such as ³H and/or ¹⁴C.

Although in this case, in the instance of the third embodiment, the diffusive gradient in thin-films device and the container are independent and temporarily rigidly connected to one another, it will be possible to have the second part of the casing as a single piece with the wall of the container (or rigidly permanently fixed to said wall) and have the first part added, for example by screwing, onto the second part. It will then only be the first part which will be independent and temporarily rigidly connected to the rest of the developing apparatus. In this case, the casing will indeed include a first part (the part illustrated in FIG. 7) and a second part then including at least the wall (and possibly the rest of the container if the wall is integral with the container) and the element illustrated in FIG. 6.

1. A diffusive gradient in thin-films device comprising a casing comprising a first part and a second part which define therebetween a housing for receiving at least one diffusion layer for a component coming from a medium outside the device, wherein the casing includes at least two holes exposing the diffusion layer to the outside of the device.

2. The device as claimed in claim 1, further including a binding layer arranged in the housing such that the diffusion layer extends from the first part as far as the binding layer which itself extends as far as the second part.

3. The device as claimed in claim 1, wherein the two holes are provided such as to both expose the diffusion layer to the medium to be studied.

4. The device as claimed in claim 1, wherein the two holes are provided in the first part of the casing such as to pass through the first part in order to firstly open out at the housing on the diffusion layer side and to secondly open out onto the outside of the device.

5. The device as claimed in claim 1, wherein a first hole is provided in the first part of the casing such as to pass through the first part in order to firstly open out at the housing on the diffusion layer side and to secondly open out onto the outside of the device and wherein a second hole is provided in the second part of the casing such as to pass through the second part in order to firstly open out at the housing on the diffusion layer side and to secondly open out onto the outside of the device.

6. The device as claimed in claim 1, wherein the various holes are provided such as to extend in directions that are parallel to one another.

7. The device as claimed in claim 1, wherein the various holes have a circular section.

8. The device as claimed in claim 1, wherein the various holes all have a cylinder shape.

9. The device as claimed in claim 1, wherein the two parts of the casing are screwed together.

10. The device as claimed in claim 1, wherein the diffusion layer is hydrogel-based.

11. An apparatus for developing a diffusive gradient in thin-films device, comprising a diffusive gradient in thin-films device as claimed in claim 5 for diffusing at least one type of component from a compartment intended to receive a solution to be studied toward a compartment intended to receive a reference solution.

12. The developing apparatus as claimed in claim 11, the apparatus includes a container including a wall separating the container into two compartments with one intended to receive the solution to be studied and the other intended to receive the reference solution, the thin-films device being arranged in a removable manner, with regard to the first part thereof and the second part thereof, at the wall.

13. The developing apparatus as claimed in claim 11, wherein the second part includes a wall separating the container into two compartments with one intended to receive the solution to be studied and the other intended to receive the reference solution, the first part being arranged in a removable manner on the second part.
